(19) United States
(12) Patent Application Publication
(10) Pub. No.: US 2013/0191153 A1
(43) Pub. Date: Jul. 25, 2013

(54) Assessing Variation In Clinical Response Data Based On A Computational Representation Of Neural Or Psychological Processes Underlying Performance On A Brain Function Test

(71) Applicants: Michael D. Lee, Irvine, CA (US); William Rodman Shankle, Corona del Mar, CA (US)

(72) Inventors: Michael D. Lee, Irvine, CA (US); William Rodman Shankle, Corona del Mar, CA (US)

(21) Appl. No.: 13/503,022

(22) PCT Filed: Jul. 8, 2011
(86) PCT No.: PCT/US11/43427

§ 371 Date: Mar. 22, 2013

Related U.S. Application Data
(60) Provisional application No. 61/363,158, filed on Jul. 9, 2010.

(51) Int. Cl. G06F 19/00; G06Q 50/24

(52) U.S. Cl. CPC G06F 19/3437; G06Q 50/24
USPC 705/3

(57) ABSTRACT

Methods, systems, and apparatus, including medium-encoded computer program products, for analyzing data include: receiving data regarding responses, and lack thereof, for items of a brain function test comprising at least one set of item responses; processing the data using a model that combines a brain function processing construct with hierarchical Bayesian analysis to measure differences among subsets of the data, wherein the brain function processing construct is a computer-based representation of neural or psychological processes underlying performance on the brain function test; and encoding a result of the processing on a computer-readable medium to supply the result to a computer device for use in an assessment related to the brain function test.

### CROSS REFERENCE TO RELATED APPLICATIONS

This application claims the benefit of the priority of U.S. Provisional Application Ser. No. 61/363,158, filed Jul. 9, 2010 and entitled “Assessing Variation In Clinical Response Data Based On A Computational Representation Of Neural Or Psychological Processes Underlying Performance On A Brain Function Test”.

### BACKGROUND

This specification relates to assessing the brain function of a person, such as can be done based on results of a cognitive test that has been administered to the person.

Various techniques have been used to measure the cognitive function of a person. For example, the National Institute of Aging's Consortium to Establish a Registry of Alzheimer's Disease (CERAD) has developed a ten word list as part of the Consortium's neuropsychological battery. The CERAD word list (CWL) test consists of three immediate-recall trials of a ten word list, followed by an interference task lasting several minutes, and then a delayed-recall trial with or without a delayed-cued-recall trial. The CWL is usually scored by recording the number of words recalled in each of the four trials. A single cutoff score for the delayed-recall trial, with or without adjustment for demographic variables, is typically used to determine whether cognitive impairment exists for a given subject.

Some have proposed various improvements to the CWL. In addition, the CWL and the improvements thereof have been used to provide memory performance testing services, via the Internet, to clinicians in daily practice. Such services allow rapid testing of individual patients and reporting on the results of such testing. Previous reports for individual cognitive performance test results have included a statement of whether the patient has been found to be normal or to have cognitive impairment. Other reports have provided different result details, and other techniques for brain condition assessment have been described. For example, see U.S. Patent Pub. No. 2009-0313047 and U.S. Patent Pub. No. 2009-0155754.

In general, Cognitive Processing (CP) models are hypothesized constructs of the psychological processes underlying the performance of memory and other cognitive abilities. For example, words at the beginning of a list are the easiest to recall after a delay (primacy effect), whereas words at the end of a list are the easiest to immediately recall (recency effect). One can construct a model of memory that incorporates these two psychological processes to see how well they explain a set of memory data. CP Models (CPMs) have been used extensively in the cognitive psychological literature, but have rarely been applied in clinical research.

### SUMMARY

This specification describes technologies relating to assessing the brain function of a person, such as can be done based on results of a brain function test. The brain's functions can be divided into 1) perceiving sensory input, 2) producing affective or emotional states, 3) focusing attention onto selected inputs, 4) performing cognitive abilities, 5) producing behavior, 6) performing social capabilities, and 7) performing functional skills. Each brain function has a set of underlying processes governing its performance. Thus, the phrase, Brain Function Processing (BFP) models, is used to cover the broader scope of models that address these brain functions, which include CPMs that address cognition. Note that BFP models for characterizing cognition are presently further developed than those for characterizing affective or emotional states, sensory perceptual abilities, focusing attention, producing behaviors, and performing social capabilities or functional skills.

Nonetheless, each of these brain functions can be assessed in connection with the systems and techniques described herein to analyze how various states (including changes in states) affect the brain's function in connection with development, aging, and various conditions, such as Parkinson's Disease, Multiple Sclerosis, Amyotrophic Lateral Sclerosis, Schizophrenia, Autism, Depression, Bipolar Disorder, Attention Deficit Disorder, Personality

Disorders, Stroke or Cerebrovascular Disease, Cardiovascular Disease, Diabetes, Chronic Renal Failure, Cancer, Traumatic Brain Injury, Menopause, Alzheimer's disease and related disorders (ADRD), and adverse effects of various medications. Note that “brain function” in this context can also be thought of as mental function, since in some implementations, the analyses can be entirely of psychological processes, without anything specific to neurology.

Graphical Hierarchical Bayesian Analysis (GHBA) is a recently developed method of using graphical models to characterize a trait by characterizing the joint distribution of latent variables and observed data, given some set of data. GHBA uses Bayesian methods to perform statistical inference. For example, one may be interested in characterizing the change in memory over time in response to one of two treatments. In this example, one wishes to estimate P(ΔMt|Tj), where ΔM is the change in memory (e.g., number of words recalled from a learned list) over some time period, t, “|” means “given”, and Tj corresponds to treatment j. GHBA has been used extensively in recent years in the area of computational cognitive science.

However, in the present disclosure, GHBA is used in the clinical research context in a methodology that involves combining GHBA and BFP constructs that characterize the processing of one or more brain functions. For example, in the context of a combination of GHBA with CPM, one can further improve the characterization of a relevant set of data for a variety of purposes, such as to better characterize changes in dementia severity as Alzheimer's disease (AD) progresses, or to better measure the effects of a treatment drug versus placebo on change in memory performance over eighteen months.

In general, an aspect of the subject matter described in this specification can be embodied in one or more methods that include receiving data regarding responses, and lack thereof, for items of a brain function test including at least one set of item responses; processing the data using a model that combines a brain function processing construct with hierarchical Bayesian analysis to measure differences among subsets of the data, wherein the brain function processing construct is a computer-based representation of neural or psychological processes underlying performance on the brain function test; and encoding a result of the processing on a computer-readable medium to supply the result to a computer device for use in an assessment related to the brain function test.

These and other embodiments can optionally include one or more of the following features. The receiving can include receiving item responses for different administrations of the same brain function test, and the processing can include using a combined GHBA-BFP model to measure differences in predictive capacity of the different administrations. The receiving can include receiving data regarding different administrations of the same brain function test to a person at different times, and the processing can include using a combined GHBA-BFP model to measure differences in brain function over the different times.

The receiving can include receiving data regarding different types of tests of the same brain function, and the processing can include using the combined model to measure differences in predictive capacity among these tests. The receiving can include receiving data regarding different administrations of the same brain function test to a person at different times, and the processing can include using the combined model to measure differences in brain function over the different times. The processing can include measuring an effect of onset or progression of a brain condition. The processing can include measuring an effect of a treatment to prevent or delay onset or progression of a brain condition. The brain condition can include Alzheimer's disease and related disorders, as well as other conditions. Moreover, the processing can include measuring an effect of progression of normal aging related changes.

The processing can use the model that combines GHBA with the brain function processing construct that represents at least one of affective or emotional state, sensory perception, focusing attention, cognitive ability, producing behavior, social capabilities, and performing functional skill or skills. The processing can include characterizing interactions between representations of two or more of affective or emotional state, sensory perception, focusing attention, cognitive ability, producing behavior, social capabilities, and performing functional skill or skills.

Other embodiments will be apparent from the specification. Accordingly, another aspect of the subject matter described in this specification can be embodied in a computer-readable medium encoding a computer program product operable to cause data processing apparatus to perform operations including those of one or more methods, as described and claimed. Moreover, a system can include a user interface device and one or more computers operable to interact with the user interface device and to perform operations including those of one or more methods, as described and claimed. In addition, an apparatus can include: an input element configured to receive input data regarding responses, and lack thereof, for items of a brain function test including at least one set of item responses; means for measuring differences among subsets of the input data using a graphical model that combines hierarchical Bayesian analysis with a brain function representation of neural or psychological processes underlying performance on the brain function test; and an output element configured to encode result data from the means for measuring.

Particular embodiments of the subject matter described in this specification can be implemented to realize one or more of the following advantages. Computer models can be developed that improve the measurement and assessment of changes in normal aging, a transition from normal aging to a disease condition, and disease progression. Change due to a treatment effect, or comparisons between different tests for the same cognitive ability, can be assessed. The types of models and item responses can include measures of affective or emotional, sensory perceptual, attentional, cognitive, functional, neurological, behavioral, and social abilities. Moreover, the combined GHBA-BFP models, such as a GHBA-CP model, can improve assessments related to a brain function test. For example, the aforementioned measures can be combined with biomarkers to enhance diagnosis of various disease states and tracking of disease course.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example system used to generate a combined analysis of data for a brain function test.

FIG. 2 shows an example process used to generate a combined analysis of data for a brain function test.

FIG. 3 shows an example of a combined GHBA-CP model.

FIG. 4 shows an example of a chart including distributions of model parameters estimated using a combined GHBA-CP model.

FIG. 5 shows examples of charts associated with estimating recognition memory (hits and false alarms) for groups and individuals.

FIG. 6 shows another example of a combined GHBA-CP model.

FIG. 7 shows examples of charts including the distribution of the mean value of the change in primacy (memory storage) per recall trial per cognitive test in an implementation.

FIG. 8 shows examples of charts including values of the primacy (memory storage) parameters for each recall trial over time for each drug- or placebo-treated subject in an implementation of a combined GHBA-CP model.

FIG. 9 shows examples of charts including the patterns of change in primacy and recency parameters for four recall trials assessed before, during and after a clinical drug study in an implementation of a combined GHBA-CP model.

FIG. 10 shows another example system used to generate a combined analysis of data for a brain function test.

### DETAILED DESCRIPTION

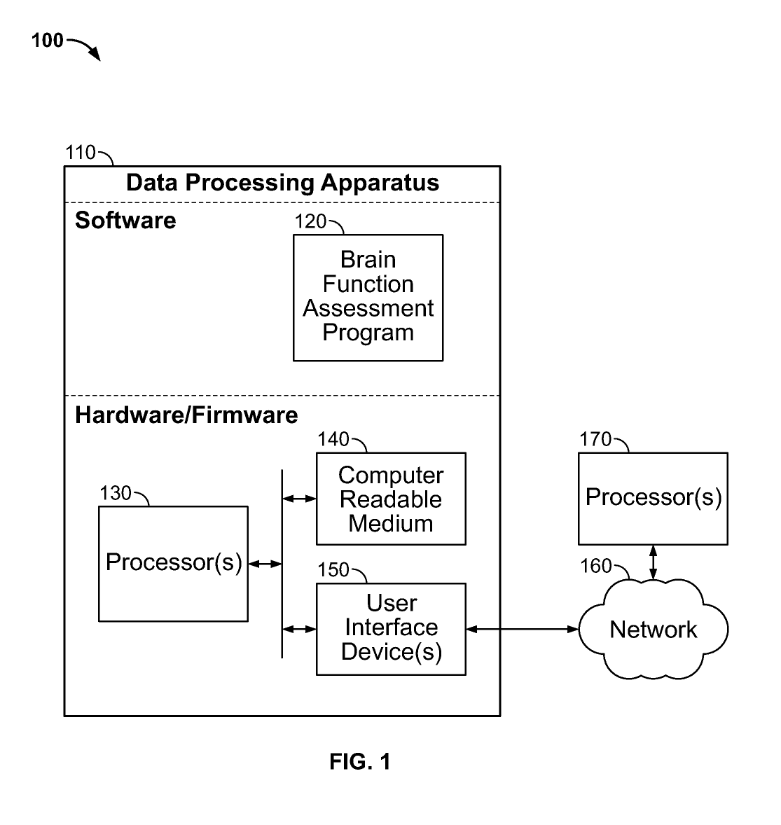

FIG. 1 shows an example system 100 used to generate a combined analysis of data for a brain function test. A data processing apparatus 110 can include hardware/firmware and one or more software programs, including a brain function assessment program 120. The brain function assessment program 120 operates in conjunction with the data processing apparatus 110 to effect various operations described in this specification. The program 120, in combination with the various hardware, firmware, and software components of the data processing apparatus, represent one or more structural components in the system, in which the algorithms described herein can be embodied.

The program 120 can be an application for determining and performing analysis on data collected to assess the brain function of a subject. A computer application refers to a computer program that the user perceives as a distinct computer tool used for a defined purpose. An application can be built entirely into an operating system or other operating environment, or it can have different components in different locations (e.g., a remote server). The program 120 can include or interface with other software such as database software, testing administration software, data analysis/computational software, and user interface software, to name a few examples. User interface software can operate over a network to interface with other processor(s). For example, the program 120 can include software methods for inputting and retrieving data associated with a brain function test, such as score results, or demographic data. The program 120 can also effect various analytic processes, which are described further below.

The data processing apparatus includes one or more processors 130 and at least one computer-readable medium 140 (e.g., random access memory, storage device, etc.). The data processing apparatus 110 can also include one or more user interface devices 150. User interface devices can include display screen(s), keyboard(s), a mouse, stylus, modems or other networking hardware/firmware, or any combination thereof to name a few examples. The subject matter described in this specification can also be used in conjunction with other input/output devices, such as a printer or scanner. The user interface device can be used to connect to a network 160, and can furthermore connect to a processor or processors 170 via the network 160 (e.g., the Internet).

Therefore, a user of the assessment program 120 does not need to be local, and may be connecting using a web browser on a personal computer, or using other suitable hardware and software at a remote location. For example, a clinician at a testing center can access a web interface via the remote processor 170 in order to input test data for a given test. The test data can be the results of an already administered test, or the test data can be the information exchanged when actually administering the test using a network based testing system. In any event, data can be transmitted over the network 160 to/from the data processing apparatus 110. Furthermore the clinician can input test data and retrieve analysis based on that data or other data stored in a database. Note that the data processing apparatus 110 can itself be considered a user interface device (e.g., when the program 120 is delivered by processor(s) 170 as a web service).

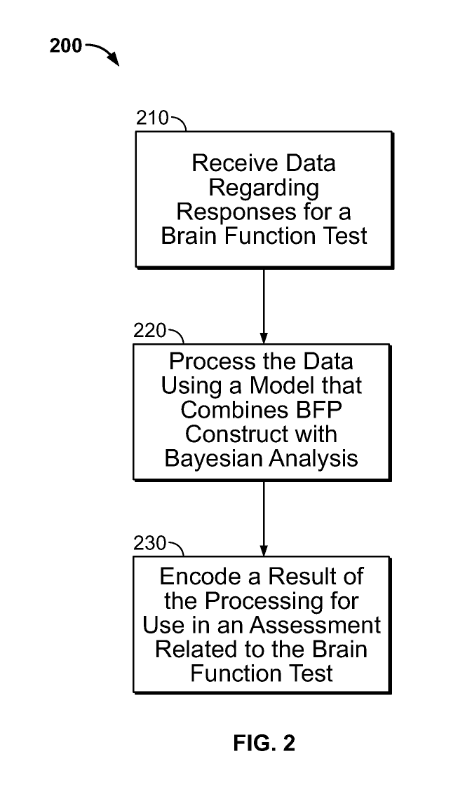

FIG. 2 shows an example process 200 used to generate a combined analysis of data for a brain function test. Data are received 210, where the data are regarding responses, and lack thereof, for items of a brain function test administered to a person. As noted above, the information can be from a previously administered test or from a test that is currently being administered. Nonetheless, the example process described in connection with FIG. 2, and other implementations of the more general concepts underlying this example process, are not practiced on the human body since such processes do not themselves involve an interaction necessitating the presence of the person.

The test can include one or more item-recall trials, or other set(s) of item responses. In general, the full set of information in the test should be recorded, including all components of the test and all subject responses. The data can be received 210 from a database, a network or web-enabled device, a computer readable medium, or a standard input output device on a computer system, to name just a few examples. The brain function test can include a test of attention and recall, and the test components can include items (e.g., words) to be recalled in one or more trials. For example, a test of attention and recall can include the CERAD word list (CWL) and/or other lists of words or items.

The words in each word list can be linguistically and statistically equivalent. The words on each distinct list can have the same level of intra-list associability and usage frequency. Each list of words can have the same level of associability and usage frequency with each and every other list of words. The word lists can be used in different parts of a test (e.g., the distracter and learning word lists can be interchanged). Moreover, the words in each word list can be presented in the same order or different order. For example, a shuffled order can be employed over multiple trials, such as in the CERAD or the ADAS-Cog (Alzheimer's Disease Assessment Scale-cognitive subscale) cognitive assessment tools. ADAS-cog consists of eleven tasks measuring different cognitive functions. The ADAS-Cog word recall test has the same general method of test administration as the CWL. Note that the ADAS-Cog does not use the 10-word list for cued recall that is used in the immediate and delayed free recall trials. It has its own set of words for that.

In general, the words in each word list should have the same difficulty of being recalled as the other words on that list, as well as the words in the other lists. For each learning trial, the words can be presented in the same order or in different order. It will be appreciated that other data formatting approaches, as well as other brain function tests and test components, are also possible. For example, in some implementations, the items (e.g., words) to be recalled in one or more trials can have differing levels of associability, and the model can account for those differing levels.

In addition, other brain function assessment tests can include, but are not limited to other multiple word recall trials, other recall or cued recall tests of verbal or non-verbal stimuli, tests of executive function, including triadic comparisons of items, (e.g., deciding which one of three animals is most different from the other two), tests of judgment, similarities, differences or abstract reasoning, tests of attention, tests that measure the ability to shift between sets or perform complex motor sequences, tests that measure planning and organizational skill, tests of simple or complex motor speed, tests of language abilities including naming, fluency or comprehension, tests of auditory, tactile, olfactory or gustatory perception, tests of visual-perceptual abilities including object recognition and constructional praxis, tests of mood or affect, tests of behavioral abilities or tests characterizing behavioral problems, tests of motor abilities or tests characterizing motor abnormalities, and tests of functional skills or tests characterizing disturbances in functional skills. Examples of recorded data can include the words recalled, the words not recalled, the order of the words recalled, time delay before recall, the order in which intrusions and repetitions are recalled, and various aspects of test performance. Moreover, the cognitive test can include one or more trials performed to determine specific cognitive functions such as physical (e.g. orientation or hand-eye coordination) or perception based tests. Additional information can be obtained in order to classify the score, such as demographic information, or the date(s) of test administration, to name just two examples.

The data are processed 220 using a model that combines a brain function processing construct with hierarchical Bayesian analysis to measure differences among subsets of the data. The hierarchical Bayesian analysis can be GHBA, where the brain function processing construct is a computer-based representation of neural or psychological processes (or both) underlying performance on the brain function test. For example, a BFP model can be applied to represent delayed recognition memory.

Delayed recognition memory is measured by a task in which a list of previously learned items—the targets—is intermixed with a list of distracter items, and the subject is asked to indicate if each item was a target or distracter. Target items correctly recognized are called “hits”. Distractor items not correctly recognized are called “false alarms”.

One CP model of delayed recognition memory consists of two parameters—discriminability and response bias. Discriminability is the ability to distinguish the target items from the distracter items, and represents an estimate of their relative memory storage strength plus the source of the memory encoding (i.e. long-term memory stores the distracters and hippocampal, or episodic memory stores the targets). Response Bias is the subject's strategy for deciding whether an item is a target or distractor. These two parameters were incorporated into a model of how a subject performs on a delayed recognition memory task. This model was then analyzed in conjunction with severity of functional impairment, using GHBA to predict subject responses to each target and distracter item.

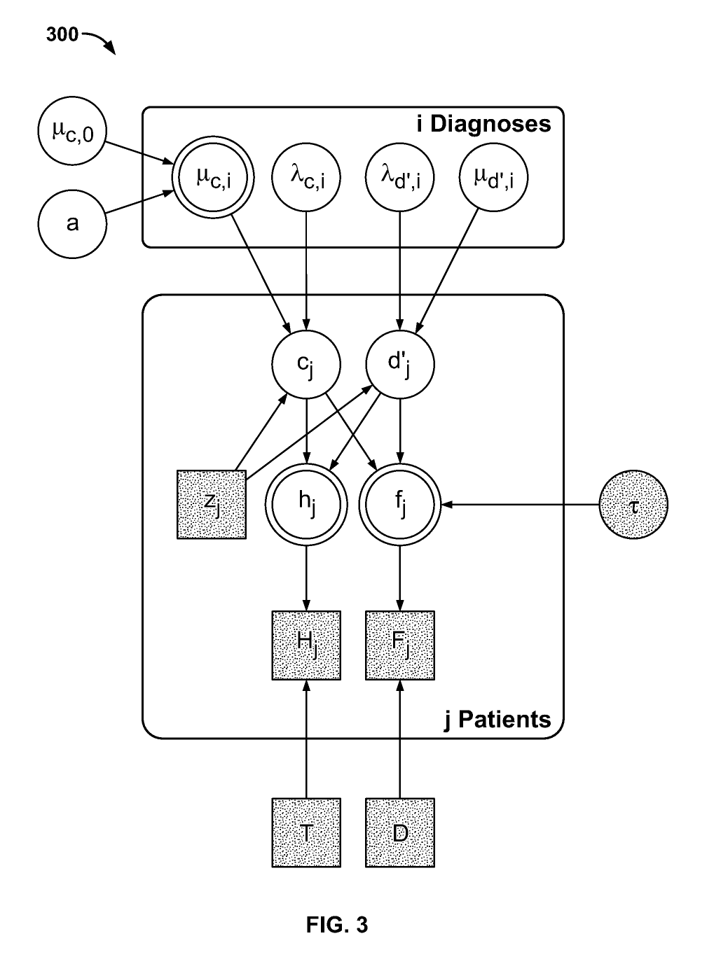

The MCI Screen (MCIS) (available from Medical Care Corporation of Irvine, Calif.) recognition memory data sample consisted of 1350 patient assessments. Based on their Functional Assessment Staging Test (FAST) severity score, these patients were normal to moderately severely demented. As shown in FIG. 3, a model 300 combining CP model with GHBA was constructed to show how the parameters of discriminability and response bias, in conjunction with FAST staging severity, predicted the hits and false alarms for each patient. In the example graph shown in FIG. 3, the shaded nodes represent observed/collected data, the unshaded nodes represent unobserved/inferred data, the square nodes represent discrete variables, the circular nodes represent continuous variables, and double circled nodes represent deterministic variables, where a deterministic variable is one whose result is defined by the values of other variables that point to the deterministic node. For example, if “c” is a deterministic variable (node) that receives input from two other variables, a and b, then “c” is determined by a function of “a” and “b”, which can be predefined for a particular implementation, or in some implementations can be defined by a user.

In FIG. 3, μ_{c,0} is the mean response bias in healthy aging persons, and a is the change in this response bias from μ_{c,0} to the value for the given FAST stage. μ_{c,i} and λ_{c,i} are the mean and precision of the response bias, c, for each FAST stage, i. μ_{d′,i} and λ_{c,i} are the mean and precision of the discriminability, d′, for each FAST stage, i. cⱼ is the response bias for patient, j. d′ⱼ is the discriminability for patient, j. zⱼ is the FAST stage of patient j. τ is the modeled hit rate for patient, j. fⱼ is the modeled false alarm rate for patient, j. τ is the ratio of the variances for target and distracter words. Hⱼ is the observed number of hits for patient, j. Fⱼ is the observed number of false alarms for patient, j. T indicates the item is a target. D indicates the item is a distracter.

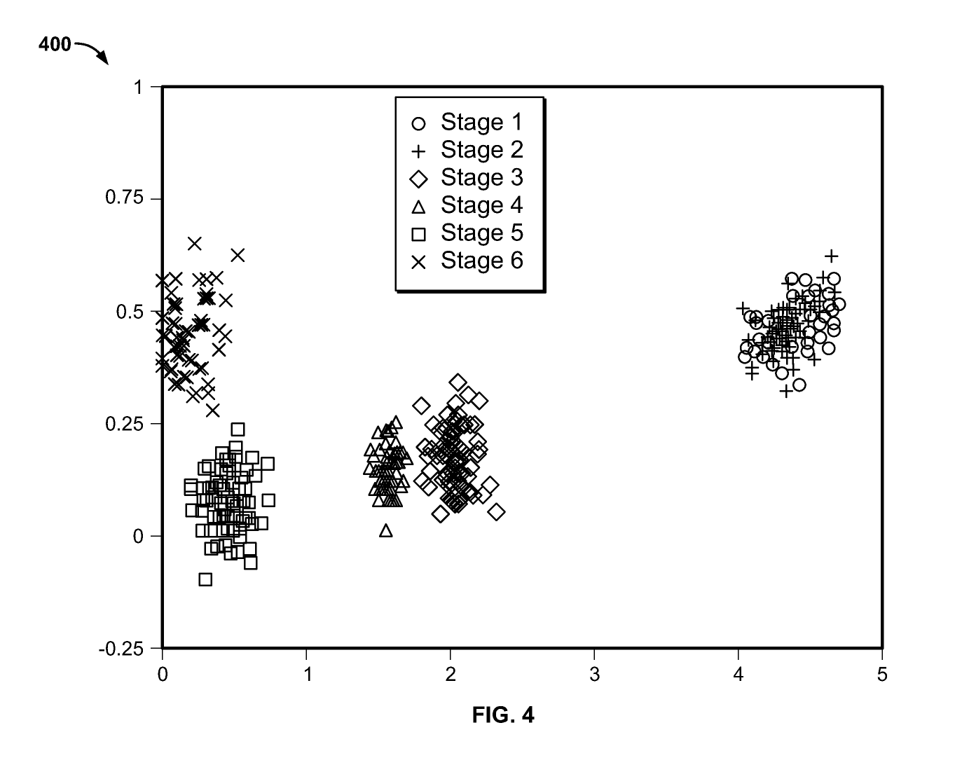

The hit, Hⱼ, and false alarm, Fⱼ, data from the patient sample were used in conjunction with the combined GHBA-CP model to estimate the CP model parameters, cⱼ and d′ⱼ, for each patient, j, and for each FAST stage, i. FIG. 4 shows in the chart 400 the inferred posterior distributions of cⱼ and d′ⱼ for each FAST severity stage. As shown, distributions of mean discriminability (X axis) and mean response bias (Y axis) derived from the MCI Screen delayed recognition memory task perfectly separate the group-level estimates of these cognitive parameters for FAST stages 1-2, 3, 4, 5 and 6 for a sample of 1350 normal to moderately severely demented patients.

The distributions of the group-level cognitive parameters for FAST stages 1 and 2 strongly overlap, but those for FAST stages 3-6 all have completely separate distributions. Target discriminability (d′ⱼ) for the delayed recognition task declines as patients become more functionally impaired. Concomitantly, response bias, cⱼ, shows a large change from FAST stages 1-2 (cⱼ˜0.5)—where subjects are biased to responding that an item is a Distracter—to FAST stages 3, 4, 5 and 6 (cⱼ˜0.25 to 0)—where subjects progress towards having no response bias for either target or distracter. Interestingly, moderately severely demented subjects (FAST stage 6) revert back towards a distracter response bias.

This BFP model shows two things: 1) that one can reliably predict a subject's delayed recognition memory performance by a combined GHBA-BFP model incorporating cognitive processes of discriminability and response bias; and 2) that functional severity (FAST staging) can be reliably predicted from these underlying cognitive processes. One can also explore why these processes change with increasing functional severity.

Combined GHBA-BFP models can be applied to a wide variety of brain function tests, and the results can be encoded 230, as needed, on a computer-readable medium. These results can be supplied to a computer device for use in an assessment related to the brain function test. The encoding can employ any of various known techniques for saving data in physical memory devices and storage devices and systems for later retrieval (e.g., ASCII (American Standard Code for Information Interchange), HTML (HyperText Markup Language), XML (eXtensible Markup Language), records in a database system). The result can include a Boolean indication or a number, such as a measure of probability. Thus, the result represents intermediate information that has diagnostic or clinical relevance, which can be used by a doctor to make a diagnosis, or can be used as input to other processes and further assessment programs.

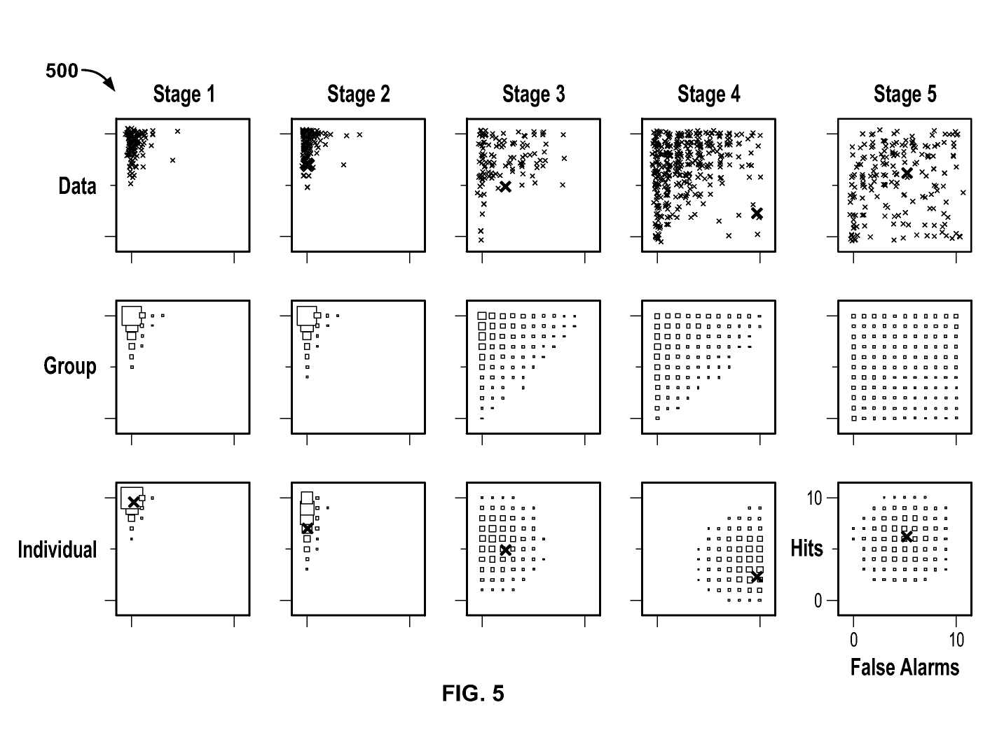

For example, the techniques described can facilitate characterizing groups of subjects (group-level predictions) and individuals (individual-level predictions). Continuing with the recognition memory data sample discussed above, FIG. 5 shows examples of charts 500 associated with group-level and individual-level estimations of recognition memory for patients in FAST stages 1-5. Row 1 (Data) shows the distribution of the observed hits and false alarms data for FAST stages 1-5. Row 2 (Group) shows the group-level inferred posterior distributions of the predicted hits and false alarms for patients in FAST stages 1-5. Row 3 (Individual) shows the individual-level inferred posterior distributions of predicted hits and false alarms for a single patient in each of FAST stages 1-5.

Larger squares in rows 2 and 3 indicate a higher probability having the predicted number of hits and false alarms for any given FAST stage. Although a patient may have only one set of observed recognition memory data, the inferred posterior distribution of their responses can be predicted by combining their observed data with the group-level predictions of the discriminability and response bias parameters in their FAST stage. In this way, an individual's recognition memory performance can be viewed in the context of their group's performance.

As another example, the techniques described can be used to assess treatment effect. The BFP model can consist of two underlying memory processes, primacy and recency. This model uses primacy, α, and recency, β, to predict whether a given subject recalled a given word in a given trial, assessment, and wordlist memory test. The wordlist memory tests used can be the ADAS-Cog and the MCI Screen. Using data from 14 patients who participated in an 18-month, FDA phase 3 clinical drug trial of Flurizan vs. placebo, patients received both tests on separate days approximately every three months.

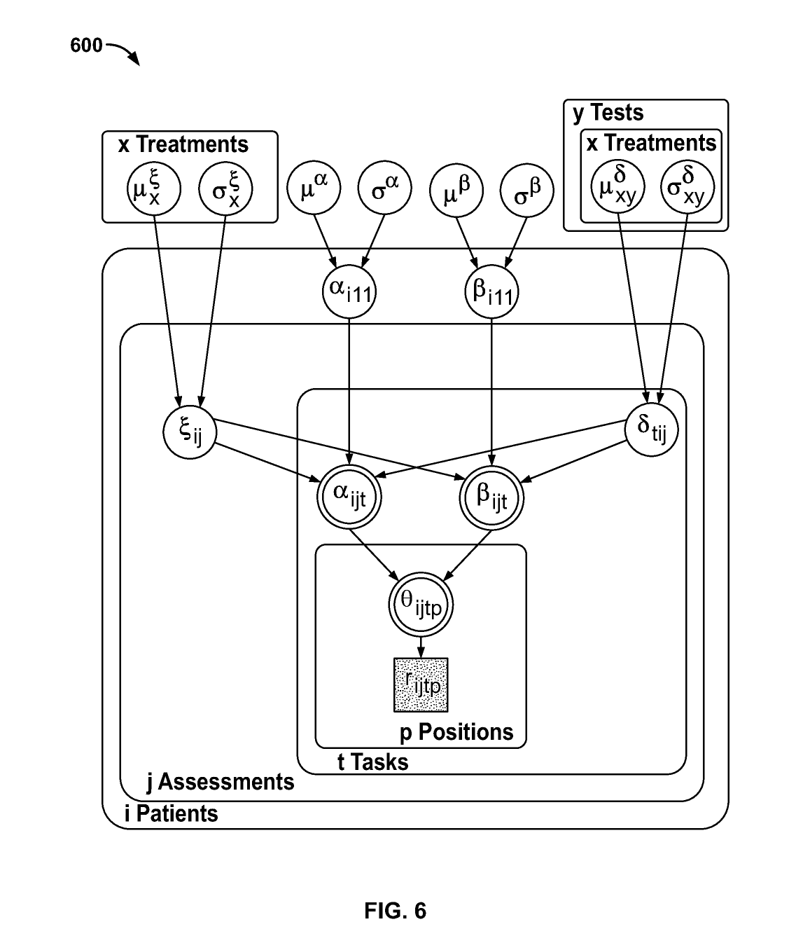

FIG. 6 shows another example 600 of a combined GHBA-CP model (in which the node representations correspond to those noted above for FIG. 3). We use a two-factor model of recall performance, driven by the primacy and recency parameters. The first word presented in a free recall trial has probability, α, of being recalled. The second word has decreased probability, α², and so on. Similarly, the last word presented has probability, β, of being recalled. The second-to-the-last word has decreased probability β², and so on. The probability of any word being recalled is the combination of the probabilities that it is recalled by primacy or recency memory processes. Formally, if we denote αᵢⱼₜ and βᵢⱼₜ as the primacy and recency parameters for the ith patient on their jth assessment during their tth recall trial, the two-factor BFP model combines them to give θᵢⱼₜₚ, the probability the pth presented word will be recalled, according to:

θₚ=1−(1−α^{p})(1−β^{10-p+1}).

rᵢⱼₜₚ˜Bernoulli(θᵢⱼₜₚ)

To determine the primacy and recency parameters for each person on each assessment and each trial, we start with their value on the first trial of the first assessment. To allow for individual differences, these parameters are assumed to be drawn from Gaussian distributions, so that:

αᵢ₁₁˜Gaussian(μ^{α}, σ^{α})_{/(0.1)}

βᵢ₁₁˜Gaussian(μ^{β}σ^{β})_{(0,1)},

with vague prior probabilities:

μ^{α}, σ^{α}, μ^{β}, σ^{β}˜Uniform(0,1).

From that starting point, the primacy and recency parameters are derived, so that:

αᵢⱼₜ=αᵢ₁₁+δ^{α}ᵢⱼₜ

βᵢⱼₜ=βᵢ₁₁+δ^{β}ᵢⱼₜ,

The changes in primacy and recency parameter values, δ^{α}ᵢⱼₜ and δ^{β}ᵢⱼₜ, for recall trial, t, patient, i, and assessment, j, are drawn from Gaussian distributions based on the means and standard deviations of these primacy and recency changes, μ^{δ}_{xy} and σ^{δ}_{xy}, for test, y, and treatment, x:

δ^{α}ᵢⱼₜ˜Gaussian(μ^{δα}_{tx(i),y(ij)}, σ^{δα}_{tx(i),y(ij)}⁾_{I(0,1)}

δ^{β}ᵢⱼₜ˜Gaussian(μ^{δβ}_{tx(i),y(ij)}, σ^{δβ}_{tx(i),y(ij)}⁾_{I(0,1)}

δ^{α}ᵢⱼₜ and δ^{β}ᵢⱼₜ, and their associated distributions, therefore measure differential sensitivity in a patient's recall performance on any given assessment and recall trial, which is due to the wordlist memory test and the treatment for that patient. The changes on each recall trial, t, relative to recall trial 1 of the first assessment of patient, i, are modeled as random effects, conditional on test type and treatment. This means, for example, that the changes in the primacy parameter for recall trials 2-4 for a given patient and assessment are randomly drawn from the same Gaussian distribution; the differences in value for δ^{α}ᵢⱼ₂, δ^{α}ᵢⱼ₃, and δ^{α}ᵢⱼ₄ are therefore modeled as random effects.

For all assessments after treatment begins (post-baseline assessments), we also modeled their associated treatment durations as having a random effect on the change in the memory processing parameters. This means that for each post-baseline assessment, j, of patient, i, the change in primacy and recency values due to the patient's treatment and its duration, ξ^{α}ᵢⱼ and ξ^{β}ᵢⱼ, was randomly drawn from a Gaussian distribution of the change due to treatment, x, per unit time (in this case, per day of treatment). Formally:

ξ^{α}ᵢⱼ˜Gaussian(μ^{ξα}ₓ₍ᵢ₎, σ^{ξα}ₓ₍ᵢ₎)_{I(-1,1)}

ξ^{β}ᵢⱼ˜Gaussian(μ^{ξβ}ₓ₍ᵢ₎, σ^{ξβ}ₓ₍ᵢ₎)_{I(-1,1)},

with vague prior probabilities

μ^{ξα}ₓ, μ^{ξβ}ₓ˜Gaussian(0,1)

σ^{ξα}ₓ, σ^{ξβ}ₓ˜Uniform(0,1).

For example, the treatment-related changes in primacy and recency parameter values for the first recall trial of the jth assessment of patient, i, are:

αᵢⱼ₁=αᵢ₁₁+ξ^{α}ᵢⱼ(dᵢⱼ−dᵢ₁)

βᵢⱼ₁=βᵢ₁₁+ξ^{β}ᵢⱼ(dᵢⱼ−dᵢ₁)

The units of ξ^{α}ᵢⱼ and ξ^{β}ᵢⱼ are “change per day”, and (dᵢⱼ−dᵢ₁) is post-baseline treatment duration. The full effects on the primacy and recency parameters for patient, i, assessment, j, and recall trial, t, that result from their baseline recall for trial 1, and their post-baseline effects due to treatment, its duration, the recall trial, and the type of test given are:

αᵢⱼₜ=αᵢ₁₁+ξ^{α}ᵢⱼ(dᵢⱼ−dᵢ₁)+δ^{α}ᵢⱼₜ

βᵢⱼₜ=βᵢ₁₁+ξ^{β}ᵢⱼ(dᵢⱼ−dᵢ₁)+δ^{β}ᵢⱼₜ.

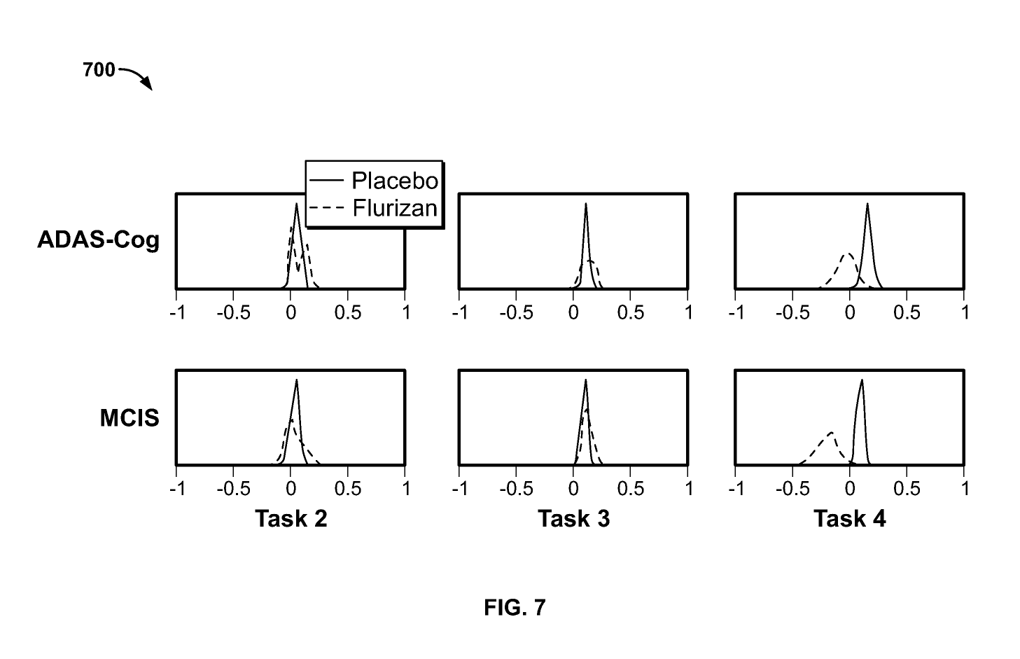

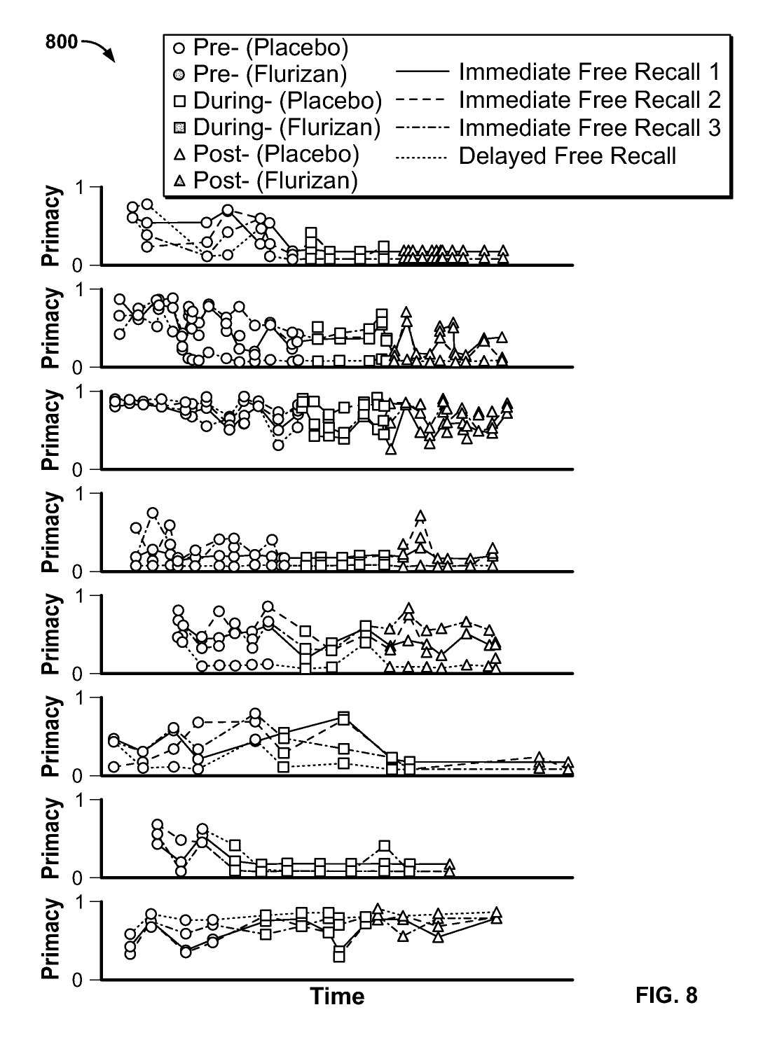

The recency parameter distributions did not differ by treatment group, recall trial or type of test given. However, the primacy parameter was affected by both the treatment group and the type of test given. The charts 700 of FIG. 7 show that the primacy parameter for the delayed recall trial (Task 4), but not for the immediate recall trials (Tasks 2 and 3) declined more for the Flurizan treatment group (dashed line) than the placebo group (solid line). FIG. 7 also shows that the MCIS test (row 2) discriminated this treatment group difference in the primacy parameter for the delayed recall trial (Task 4) better than did the ADAS-Cog test (row 1). One way of formalizing this test type difference is via the standard d′ measure of discriminability (the differences in means normalized by the pooled standard deviation of the inferred posterior distributions). That comparison gives d′=4.3 for the MCIS and d′=3.1 for the ADAS-Cog—a 39% improvement in discriminability for the MCIS test.

FIG. 7 shows the distribution of the mean value of the change in primacy (memory storage) in the learning (Tasks 2 and 3) and delayed recall (Task 4) trials, measured by the ADAS-Cog and the MCIS tests, over 18 months compared to baseline, for Flurizan and placebo. The Flurizan group shows a significantly greater decline in memory storage than placebo during delayed free recall (Task 4) for both tests. The MCIS discriminates this treatment effect 39% better than the ADAS-Cog. Thus, these findings show the ability of the present systems and techniques to detect treatment effects that were missed by the currently used methods required for FDA clinical drug trials. They also show the ability to compare different tests in terms of their ability to detect the effects of greatest interest, including treatment effects, transition from normal aging to cognitive impairment, and disease progression.

The present systems and techniques can also be used to measure how a treatment, started at some point in the course of a patient's condition, affects brain function compared to either before starting the treatment, after stopping the treatment, or both. This means that the present technology can also be used to evaluate groups and individuals who receive a specified treatment sometime during the course of their condition, and not just be used to compare two treatments. Examples of a patient's condition include normal aging, AD, Lewy body disease, stroke, diabetes, cancer and heart disease. Thus, change in memory performance due to treatment or disease can be readily assessed in clinical practice settings.

In the case of the 18 month FDA trial of Flurizan vs. placebo, MCIS cognitive data were available prior to and after ending the trial for the same 14 AD patients previously discussed. The model parameters of recency and primacy were separately estimated prior to, during, and after stopping the trial in each patient and in each treatment group.

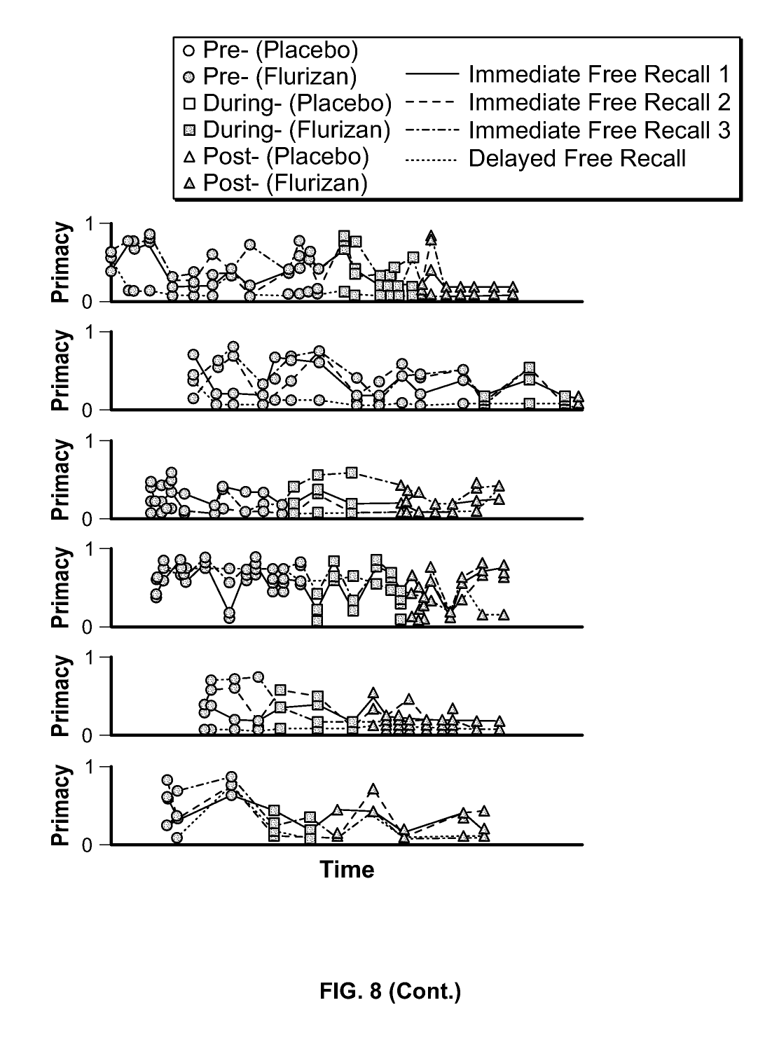

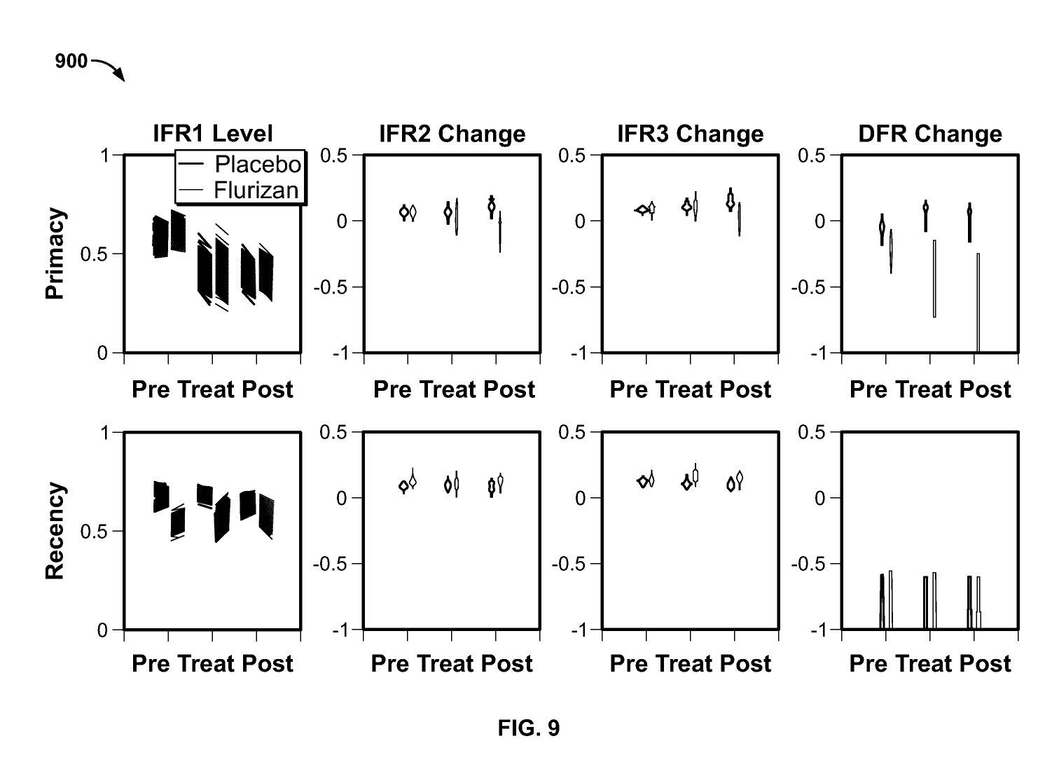

FIG. 8 shows examples of charts 800 showing the inferred posterior distribution values for the primacy parameters fit separately to the three learning trials and one delayed free recall trial (the four curves within each plot) for every patient (each plot is a patient) on every assessment (the solid or hollow colored dots each represent the results of an assessment) before (circles), during (squares) and after (triangles) the Flurizan vs. placebo trial. The first column of plots (hollow circles) show the 8 placebo-treated, and the second column of plots (filled circles) show the 6 Flurizan-treated patients. The patterns of change in primacy before, during and after the FDA trial are complex and can be more easily characterized by a change analysis, as discussed further below in connection with FIG. 9.

FIG. 9 shows examples of charts 900 including a pattern of change in primacy and recency for recall trials in an implementation. To perform the change analysis, we constructed a combined GHBA-BFP model that estimates primacy (1^{st} row) and recency (2^{nd} row) parameters for before (labeled Pre), during (labeled Treat), and after (labeled Post) the FDA trial for Flurizan (thin lines on the right side in each of the three groups in each of the charts) and placebo (thick lines on the left side in each of the three groups in each of the charts) for recall trials 1-4 (columns IFR1-3, and DFR). The model predicts the linear changes in these memory parameters within each assessment phase, each treatment group and each recall trial. The left-most column shows the predicted starting levels and slopes for the primacy and recency parameters for immediate free recall trial 1 (IFR1), with the levels and slopes for individuals drawn from Gaussian distributions at the group level (i.e. assessment phase, treatment group). This column shows no treatment group difference in the primacy parameter for any assessment phase. However, the recency parameter for IFR1 shows a small treatment group difference favoring Flurizan (upward slope) in the Pre and Treat assessment phases. This treatment group difference in the IFR1 recency parameter is lost after the trial ends.

For subsequent recall trials (IFR2, IFR3, and DFR Change), the change in parameter value relative to IFR1 for each treatment group and assessment phase. The primary finding is a large treatment group difference in the primacy parameter, which favored placebo during the DFR Change recall trials of the Treat and Post assessment phases. This means that the harmful effect of Flurizan persisted after treatment was stopped. This harmful effect of Flurizan is consistent with a greater decline in dementia severity that was observed among Flurizan-treated patients in the full FDA trial of 1649 AD patients. Because Flurizan—a gamma secretase inihibitor—inhibits the breakdown of amyloid precursor protein into both the neurotoxic, beta amyloid-42, and the neuroprotective, alpha amyloid-17, the extended finding suggests that the effect of reducing alpha amyloid-17 is much more harmful to memory storage than reducing beta amyloid-42. This application of a combined GHBA-BFP model suggests that much more useful knowledge can be obtained if the FDA required cognition of AD patients to be monitored for some period of time prior to starting the treatment vs. placebo phase, and for some period of time after stopping it.

Regardless of the type of brain condition being assessed, additional operations can be performed, free recall and delayed recognition memory techniques can be employed, and the present techniques can be used to better characterize individuals or groups with any disorder that can result in abnormal movement, sensory perceptual abnormalities, affective or emotional disturbance, attentional disturbances, cognitive impairment or dementia, behavioral disturbances, or impairment of functional skills. It can also be used to better characterize individuals or groups with normal life changes, including development, adolescence, early adulthood and aging thereafter.

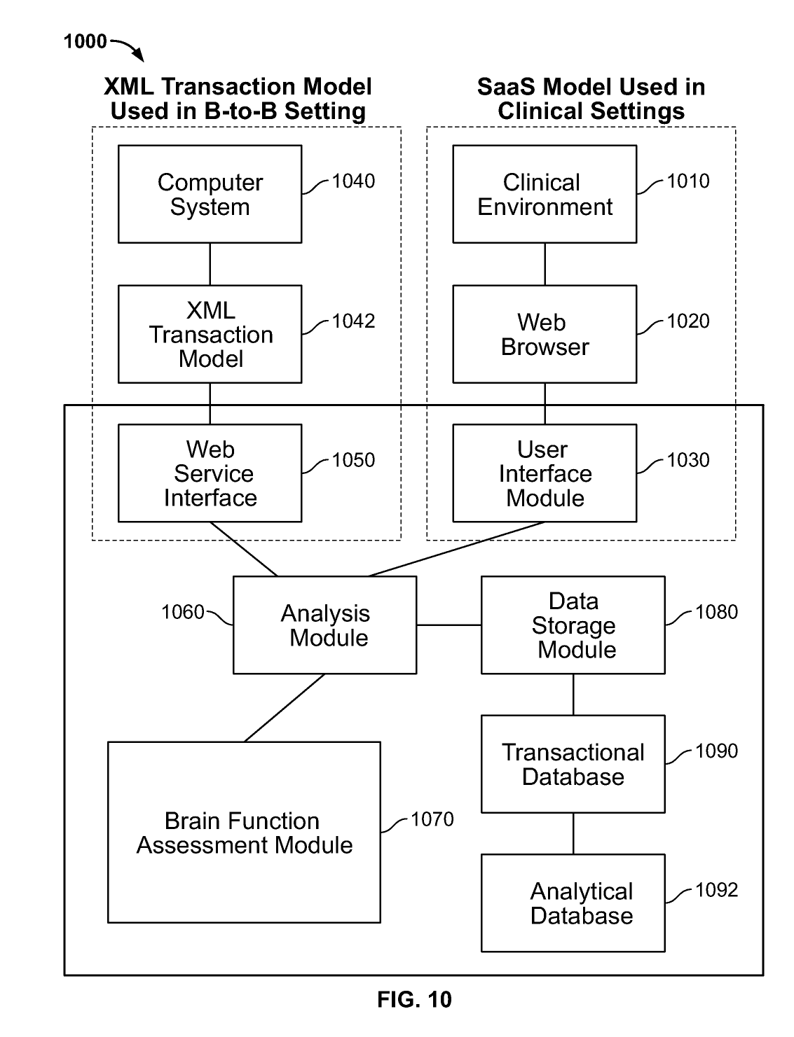

FIG. 10 shows another example system 1000 used to generate a combined analysis of data for a brain function test. The example system described can perform a variety of functions including data analysis, storage and viewing, and remote access and storage capabilities useful for generating and using the analysis techniques described herein.

A Software as a Service (SaaS) model can provide network based access to the software used to generate the analysis. This central management of the software can provide advantages, which are well known in the art, such as offloading maintenance and disaster recovery to the provider. A user, for example, a test administrator within a clinical environment 1010, can access test administration software within the test administration system via a web browser 1020 or other graphical user interface program (e.g., an application for a smart phone or a tablet computer). A user interface module 1030 receives and responds to the test administrator interaction.

In addition, a customer's computer system 1040 can access software and interact with the test administration system using an eXtensible Markup Language (XML) transactional model 1042. The XML framework provides a method for two parties to send and receive information using a standards-based, but extensible, data communication model. A web service interface 1050 receives and responds to the customer computer system 1040 in XML format. For example, an XML transactional model can be useful for storage and retrieval of the structured data relating to the cognitive function index.

An analysis module 1060 analyses inputs from the web service interface 1050 and the user interface module 1030, and produces test results to send. The analysis module uses a brain function assessment module 1070 to perform the test analysis. The brain function assessment module 1070 can, for example, incorporate the methods described elsewhere in this specification.

A data storage module 1080 transforms the test data collected by the user interface module 1030, web service interface 1050, and the resulting data generated by the analysis module 1060 for permanent storage. A transactional database 1090 stores data transformed and generated by the data storage module 1080. For example, the transactional database can keep track of individual writes to a database, leaving a record of transactions and providing the ability to roll back the database to a previous version in the event of an error condition. An analytical database 1092 can store data transformed and generated by the data storage module 1080 for data mining and analytical purposes.

As will be appreciated, the above described systems and techniques can be used in various applications, with individuals or groups in any of various states. For example, in some implementations, the differential performance among tests of the same cognitive ability can be measured. The differences found between the ADAS-Cog and MCIS tests exemplified this particular application. As previously shown, the combined GHBA-BFP model showed that the MCIS detected a 39% greater treatment group difference in memory storage than the test required by the FDA for AD clinical trials (the ADAS-Cog). To our knowledge, the ability to compare such differences in test performance has not been previously possible because of an inability to translate the different ways that a given cognitive ability is measured by different tests, such as the ADAS-Cog, MCIS, CVLT, AVLT, HVLT and other memory tests.

In some implementations, changes in a given state can be readily measured. In the analysis of the FDA trial, the state examined was AD. Other states we can examine include other dementing disorders (Lewy Body Disease, Cerebrovascular disease, Frontal Temporal Lobe disease, Traumatic Brain Injury, depression and mixed etiologies), and normal aging. The changes in cognition due to these conditions, in terms of the underlying processes that produce these cognitive abilities, can be characterized using combined GHBA-BFP models.

In some implementations, the effects of treatments can be measured to prevent or delay the onset of disease symptoms (e.g., ADRD symptoms). Using the methods discussed for the FDA trial, we can evaluate a cohort of patients with a set of ADRD risk factors who have self-selected a set of treatments or interventions for those risk factors. The modeling approach focuses on the changes in key cognitive parameters, such as memory storage during delayed free recall, in order to determine the effect of any treatment prior to, during and after its use. The “state” examined is, in this case, a healthy aging cohort. A similar analysis can be done to assess functional and affective changes in healthy aging, as well as the impact of treatment upon these changes.

In some implementations, changes due to transition from normal aging to ADRD can be measured. Once changes due to healthy aging and changes due to AD and related disorders are characterized, cognition and function can be monitored in a healthy aging cohort, and changes in key parameters (e.g., memory storage during DFR) can be detected. Changes that exceed the bounds established by the analysis of the healthy aging cohort are compared to those established by the analysis of the ADRD cohort in order to identify likely transitions from healthy aging to ADRD.

In some implementations, changes due to ADRD disease progression are measured. The progression of AD and related disorders can be characterized in terms of the underlying cognitive, affective, functional and behavioral component processes involved in the production of these abilities, using combined GHBA-BFP models for each ability, in order to better establish their course during the progression of the various ADRD etiologies previously specified. Characterization of the course of these abilities is essential to identifying more effective treatments for AD and related disorders.

In some implementations, treatment effect can be measured in ADRD symptomatic phases. Once the progression of cognitive, functional, affective and behavioral abilities in AD and related disorders has been characterized in terms of their component processes, combined GHBA-BFP models can be used to characterize the effect of various treatments. This can be done in clinical samples by characterizing the progression of an individual or group of individuals prior to, during and after the treatment. In placebo-controlled clinical trials, it can be characterized by comparison to the treatment effect of the placebo group.

In some implementations, relation between changes in cognition and functional abilities can be measured. The GHBA-BFP model can be readily extended to incorporate parameters characterizing the interactions between cognitive, functional, affective and behavioral abilities. This interaction can be modeled in terms of the underlying components that drive these abilities.

In some implementations, differential diagnosis of ADRD etiology can be supported. By characterizing the changes in component parameters underlying a specific ability, the effect of each major ADRD etiology can be examined early on as well as during its progression. The differences found for such changes will serve as useful confirmatory tools for differential diagnosis of ADRD etiologies.

In some implementations, overall AD and ADRD risk can be measured. The longitudinal monitoring of cognition, affect and function in a healthy aging cohort can be combined in a GHBA-BFP model to assess the risk of developing AD or ADRD given the risk factor vector and risk factor treatment vector of any given individual or group of individuals.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal that is generated to encode information for transmission to suitable receiver apparatus for execution by a computer. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A computer-implemented method comprising:
receiving data regarding responses, and lack thereof, for items of a brain function test comprising at least one set of item responses;
processing the data using a model that combines a brain function processing construct with hierarchical Bayesian analysis to measure differences among subsets of the data, wherein the brain function processing construct is a computer-based representation of neural or psychological processes underlying performance on the brain function test; and
encoding a result of the processing on a computer-readable medium to supply the result to a computer device for use in an assessment related to the brain function test.

2. The method of claim 1, wherein the receiving comprises receiving item responses for different administrations of the same brain function test, and the processing comprises using a combined GHBA-BFP model to measure differences in predictive capacity of the different administrations.

3. The method of claim 1, wherein the receiving comprises receiving data regarding different administrations of the same brain function test to a person at different times, and the processing comprises using a combined GHBA-BFP model to measure differences in brain function over the different times.

4. The method of claim 1, wherein the receiving comprises receiving data regarding different types of tests of the same brain function, and the processing comprises using the combined model to measure differences in predictive capacity among these tests.

5. The method of claim 1, wherein the receiving comprises receiving data regarding different administrations of the same brain function test to a person at different times, and the processing comprises using the combined model to measure differences in brain function over the different times.

6. The method of claim 5, wherein the processing comprises measuring an effect of onset or progression of a brain condition.

7. The method of claim 5, wherein the processing comprises measuring an effect of a treatment to prevent or delay onset or progression of a brain condition.

8. The method of claim 5, wherein the brain condition comprises Alzheimer's disease and related disorders.

9. The method of claim 5, wherein the processing comprises measuring an effect of progression of normal aging related changes.

10. The method of claim 1, wherein the processing uses the model that combines GHBA with the brain function processing construct that represents at least one of affective or emotional state, sensory perception, focusing attention, cognitive ability, producing behavior, social capabilities, and performing functional skill or skills.

11. The method of claim 10, wherein the processing comprises characterizing interactions between representations of two or more of affective or emotional state, sensory perception, focusing attention, cognitive ability, producing behavior, social capabilities, and performing functional skill or skills.

12. An apparatus comprising:
an input element configured to receive input data regarding responses, and lack thereof, for items of a brain function test comprising at least one set of item responses;
means for measuring differences among subsets of the input data using a graphical model that combines hierarchical Bayesian analysis with a brain function representation of neural or psychological processes underlying performance on the brain function test; and
an output element configured to encode result data from the means for measuring.

13. (canceled)

14. A system comprising:
a user interface device; and
one or more computers operable to interact with the user interface device and to perform operations comprising
receiving data regarding responses, and lack thereof, for items of a brain function test comprising at least one set of item responses,
processing the data using a model that combines a brain function processing construct with hierarchical Bayesian analysis to measure differences among subsets of the data, wherein the brain function processing construct is a computer-based representation of neural or psychological processes underlying performance on the brain function test, and
encoding a result of the processing on a computer-readable medium to supply the result to a computer device for use in an assessment related to the brain function test.

15. The system of claim 14, wherein the receiving comprises receiving item responses for different administrations of the same brain function test, and the processing comprises using a combined GHBA-BFP model to measure differences in predictive capacity of the different administrations.

16. The system of claim 14, wherein the receiving comprises receiving data regarding different administrations of the same brain function test to a person at different times, and the processing comprises using a combined GHBA-BFP model to measure differences in brain function over the different times.

17. The system of claim 14, wherein the receiving comprises receiving data regarding different types of tests of the same brain function, and the processing comprises using the combined model to measure differences in predictive capacity among these tests.

18. The system of claim 14, wherein the receiving comprises receiving data regarding different administrations of the same brain function test to a person at different times, and the processing comprises using the combined model to measure differences in brain function over the different times.

19. The system of claim 18, wherein the processing comprises measuring an effect of onset or progression of a brain condition.

20. The system of claim 18, wherein the processing comprises measuring an effect of a treatment to prevent or delay onset or progression of a brain condition.

21. The system of claim 18, wherein the brain condition comprises Alzheimer's disease and related disorders.

22. The system of claim 18, wherein the processing comprises measuring an effect of progression of normal aging related changes.

23. The system of claim 14, wherein the processing uses the model that combines GHBA with the brain function processing construct that represents at least one of affective or emotional state, sensory perception, focusing attention, cognitive ability, producing behavior, social capabilities, and performing functional skill or skills.

24. The system of claim 23, wherein the processing comprises characterizing interactions between representations of two or more of affective or emotional state, sensory perception, focusing attention, cognitive ability, producing behavior, social capabilities, and performing functional skill or skills.
